(19) United States
(12) Patent Application Publication
(10) Pub. No.: US 2008/0195313 A1
(43) Pub. Date: Aug. 14, 2008

(54) Method, Computer Program Product and Apparatus for Parameter Optimization Via Logged Data Visualization

(75) Inventor: Aaron Coleman, Broken Arrow, OK (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Navico Inc.

(21) Appl. No.: 11/674,801

(22) Filed: Feb. 14, 2007

(51) Int. Cl. G01C 21/34

(52) U.S. Cl. 701/210

(57) ABSTRACT

An apparatus for utilization of logged data visualization for optimization of an operational parameter associated with a particular route may include a route determining element, a data recording element and a data display element. The data recording element may be configured to provide stored route data associated with each of one or more stored routes. Each stored route may include respective a first point and a second point. The route determining element may be configured to receive current route data associated with a current route. The current route may include respective a first point to a second point. The route data may be received during transit of the current route and the route determining element may compare the stored route data to the current route data to determine a stored route the same or similar to the current route. The respective stored route may be determined based upon at least the first point of the current route being the same or similar to the first point of the respective stored route. The data display element may be in communication with the route determining element and the data recording element. The data display element may be configured to present a display including at least a portion of the current route data and at least a portion of the stored route data for the respective stored route.

### FIELD OF THE INVENTION

Embodiments of the present invention generally relate to parameter optimization and, more particularly, relate to utilization of logged data visualization for optimization of an operational parameter associated with a particular route.

### BACKGROUND OF THE INVENTION

A number of different satellite navigation systems are in use today, including, for example, the global positioning system (GPS), Global Navigation Satellite System (GNSS), International GNSS Service (IGS), NAVSTAR, GLONASS, and derivations thereof. One of these satellite navigation systems, GPS, enables very accurate location determination or position fixing by utilizing measurements of precise timing signals broadcast from a constellation of more than two dozen GPS satellites in orbit around the earth. Location can be determined, for example, in terms of longitude, latitude, and altitude regardless of time, weather and location. Accordingly, GPS has become a vital tool for not only navigation in the air, on land and at sea, but also for map-making and land surveying.

Another satellite navigation system, IGS, has incorporated NAVSTAR satellites of the United States and GLONASS satellites from Russia along with additional satellite constellations to provide a very robust navigation capability. Generally, IGS provides increased precision in location determination and enables the utilization of enhancements in the capabilities of satellite navigation system devices.

Given the clear utility of satellite navigation systems, satellite navigation receivers or modules capable of receiving satellite navigation-related broadcasts for location determination are in high demand for the provision of increased levels of service within numerous industries. Additionally, given the continuing reduction in the size and cost of highly-capable electronic devices, satellite navigation modules are becoming more commonly encountered and used by consumers. For example, the telecommunications industry has placed satellite navigation modules in mobile terminals such as cellular phones for the provision of location-based services; the automotive industry has placed satellite navigation modules in automobiles for the provision of guidance services; and the maritime industry has placed satellite navigation modules on ships for the provision of services related to safe navigation.

Although existing satellite navigation modules and techniques are adequate when used in the context of guidance services, it is typically desirable to improve upon such modules and techniques.

### BRIEF SUMMARY OF THE INVENTION

Accordingly, in order to provide a mechanism by which to perform optimization of an operational parameter associated with a route, exemplary embodiments of the present invention provide a method, computer program product and apparatus for providing visualization of logged data in connection with operational parameter optimization. Exemplary embodiments of the present invention may be employed in a satellite navigation system (e.g., GPS, IGS, GNSS, NAVSTAR, GLONASS, etc.) module. Thus, for example, stored or logged data corresponding to actual previously transited routes may be utilized to provide a capability to utilize best or optimal routes based on real data and compare such real world optimal routes to a current route while transiting the current route.

In one exemplary embodiment, a method is provided for utilization of logged data visualization for optimization of an operational parameter associated with a particular route. The method may include providing stored route data associated with each of one or more stored routes in which each stored route including respective a first point and a second point and receiving current route data associated with a current route. The current route may include respective a first point to a second point and the route data may be received during transit of the current route. The method may further include comparing the stored route data to the current route data to determine a stored route the same or similar to the current route. The respective stored route may be determined based upon at least the first point of the current route being the same or similar to the first point of the respective stored route. The method may further include presenting a display including at least a portion of the current route data and at least a portion of the stored route data for the respective stored route.

In another exemplary embodiment, a computer program product is provided for utilization of logged data visualization for optimization of an operational parameter associated with a particular route. The computer program product includes at least one computer-readable storage medium having computer-readable program code portions stored therein. The computer-readable program code includes multiple executable portions. The first executable portion is for providing stored route data associated with each of one or more stored routes in which each stored route including respective a first point and a second point. The second executable portion is for receiving current route data associated with a current route. The current route may include respective a first point to a second point and the route data may be received during transit of the current route. The third executable portion is for comparing the stored route data to the current route data to determine a stored route the same or similar to the current route. The respective stored route may be determined based upon at least the first point of the current route being the same or similar to the first point of the respective stored route. The fourth executable portion is for presenting a display including at least a portion of the current route data and at least a portion of the stored route data for the respective stored route.

In yet another exemplary embodiment, an apparatus is provided for utilization of logged data visualization for optimization of an operational parameter associated with a particular route. The apparatus may include a route determining element, a data recording element and a data display element. The data recording element may be configured to provide stored route data associated with each of one or more stored routes. Each stored route may include respective a first point and a second point. The route determining element may be configured to receive current route data associated with a current route. The current route may include respective a first point to a second point. The route data may be received during transit of the current route and the route determining element may compare the stored route data to the current route data to determine a stored route the same or similar to the current route. The respective stored route may be determined based upon at least the first point of the current route being the same or similar to the first point of the respective stored route. The data display element may be in communication with the route determining element and the data recording element. The data display element may be configured to present a display including at least a portion of the current route data and at least a portion of the stored route data for the respective stored route.

Exemplary embodiments of the invention provide an ability to visually compare route data which may be associated with a particular operational parameter with a corresponding route data from a corresponding route or route segment based on logged or stored data associated with the corresponding route or route segment. Accordingly, for example, progress along a current route in terms of the route data and/or operational parameter may be continuously displayed along with a simultaneous display of stored route data and/or operational parameter information which was gathered from a previous traverse of at least the current portion of the route.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a basic block diagram illustrating a system that may benefit from exemplary embodiments of the present invention;

FIG. 2 illustrates a basic block diagram of a head unit according to an exemplary embodiment of the present invention;

FIG. 3 illustrates a functional block diagram of a navigation system for providing utilization of logged data visualization for optimization of an operational parameter associated with a particular route according to an exemplary embodiment of the present invention;

FIG. 4 illustrates a diagram of a display of route data according to an exemplary embodiment of the present invention;

FIG. 5 illustrates a diagram of a display of route data according to another exemplary embodiment of the present invention;

FIG. 6 illustrates a diagram of a display of route data according to another exemplary embodiment of the present invention; and

FIG. 7 is a flowchart including various operations of a method of providing utilization of logged data visualization for optimization of an operational parameter associated with a particular route according to one exemplary embodiment of the present invention.

### DETAILED DESCRIPTION OF THE INVENTION

Embodiments of the present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like reference numerals refer to like elements throughout.

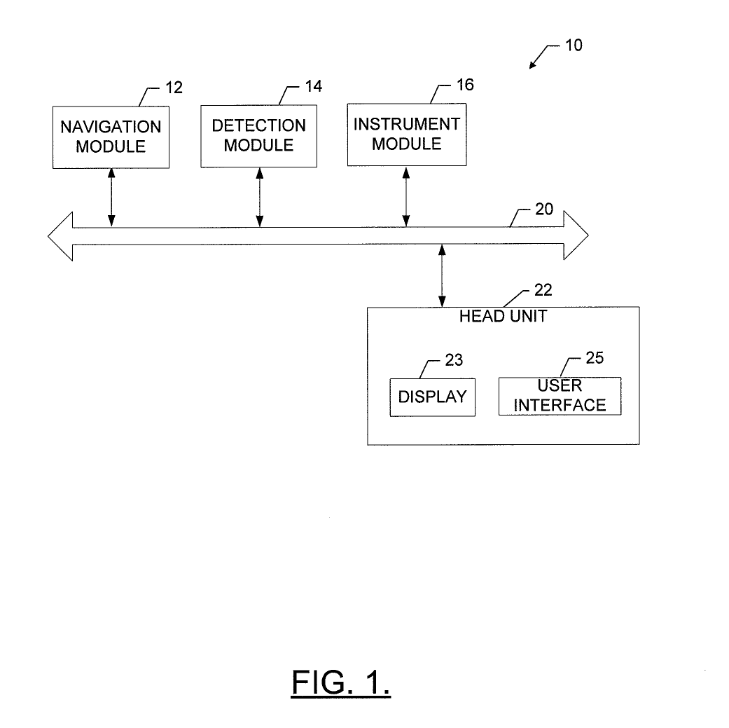

FIG. 1 is a basic block diagram illustrating a system 10 that may benefit from exemplary embodiments of the present invention. As shown and described herein, the system 10 could be part of a marine system, a land-based guidance system or the like. As shown, the system 10 may include a number of different modules, each of which may comprise any device or means embodied in either hardware, software, or a combination of hardware and software configured to perform one or more functions, including those attributed to the respective modules as described herein. For example, the system 10 may include a navigation module 12, a detection module 14, an instrument module 16 and/or numerous other peripheral devices or modules. One or more of the modules may be configured to communicate with one or more of the other modules, and/or with a head unit 22 that may be configured to process and/or display data, information or the like (“data,” “information,” or the like generally referred to herein as “data”) from one or more of the modules. The modules and/or head unit may be configured to communicate with one another in any of a number of different manners including, for example, via a network 20. In this regard, the network 20 may be any of a number of different communication backbones or frameworks including, for example, the NMEA 2000 framework. Although FIG. 1 shows a number of modules as being separate elements from the head unit 22 and in communication with the head unit 22 via the network 20, it should be understood that any one or more of the modules could alternatively form a portion of the head unit 22 or be directly in communication with the head unit 22.

The head unit 22 may include a display 23 configured to display images, and a user interface 25 configured to receive an input from a user of the system 10. The display 23 may be, for example, a conventional LCD (liquid crystal display) or any other suitable display known in the art. And the user interface 25 may include, for example, a keyboard, keypad, function keys, mouse, scrolling device, touch screen and/or any other mechanism by which a user may interface with the system.

The navigation module 12 may include any of a number of different navigation devices configured to receive navigation data and generate location data indicative of the location of the navigation module, and thus any entity (e.g., marine craft, motor vehicle, etc.) employing the system 10. For example, the navigation module 12 may include one or more GPS (global positioning system) or other satellite navigation system modules, inertial navigation system modules, terrestrial navigation system modules (e.g., LORAN-C) or the like.

The detection module 14 may include any of a number of different detection and ranging systems for detecting vessels, structures or aids to navigation. For example, the detection module 14 may include a sonar system that uses sound wave transmissions to determine water depth or detect fish and/or other waterborne contacts. Additionally or alternatively, for example, the detection module 14 may include a conventional radar system that uses radio frequency transmissions to determine ranging data and other position-related data associated with surface or airborne vessels or aids to navigation. When the system 10 is utilized in connection with a marine system, the system may include radar and/or sonar systems as described above. However, when the system 10 is utilized in connection with a land-based guidance system, the system 10 may omit the detection module.

The instrument module 16 may be configured to receive one or more operational parameters, or more particularly analog and/or digital data related to one or more operational parameters, measured at one or more particular devices, and communicate those operational parameter(s) to the network 20, oftentimes in a digital format. For example, the instrument module 16 may be configured to receive operational parameters from numerous sensors configured to measure operational parameters at numerous corresponding shipboard or motor vehicle devices. These parameters may include, for example, fuel level, speed, engine RPM (revolutions per minute), engine fluid temperature and/or pressure, battery state of charge, ambient air and/or water temperature, salinity or the like. The instrument module 16 may therefore include or otherwise be in communication with any of a number of different devices such as, for example, a tachometer, speedometer, thermometer, pressure gauge, volt meter, ammeter, fuel level sensor, etc. Where applicable, the instrument module 16 may include analog-to-digital conversion capabilities to communicate digital data to the network 20.

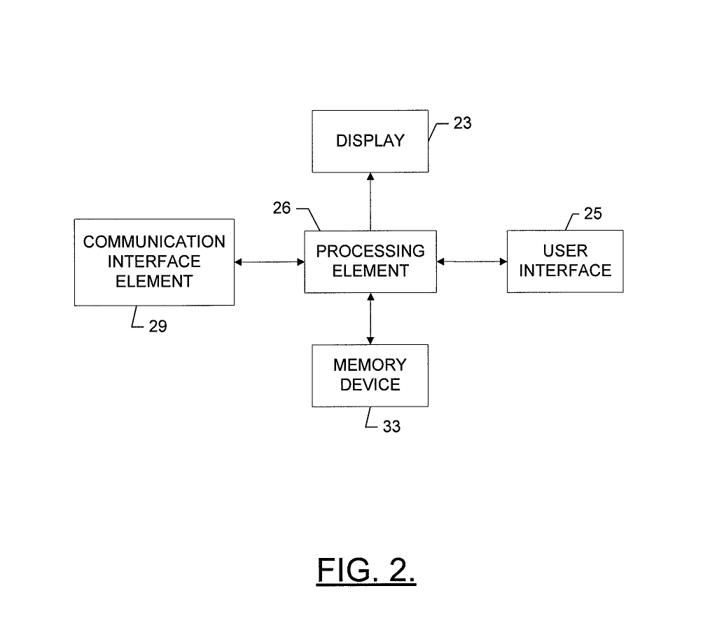

As indicated above, the head unit 22 may be configured to receive data via the network 20, and process and/or display that and/or other data. FIG. 2 illustrates a basic block diagram of the head unit 22 according to an exemplary embodiment of the present invention. As shown, in addition to a display 23 and user interface 25, the head unit 22 may include a processing element 26, communication interface element 29 and memory device 33. The memory device 33 may include, for example, volatile and/or non-volatile memory. The memory device 33 may be configured to store information, data, applications, instructions or the like for enabling the head unit to carry out various functions in accordance with exemplary embodiments of the present invention. For example, the memory device 33 could be configured to buffer input data for processing by the processing element 26. Additionally or alternatively, the memory device 33 could be configured to store other data including, for example, operational parameter data associated with one or more particular routes and/or route segments.

The processing element 26 may be embodied in a number of different ways. For example, the processing element 26 may be embodied as a processor, a coprocessor, a controller or various other processing means or devices including integrated circuits such as, for example, an ASIC (application specific integrated circuit). In an exemplary embodiment, the processing element 26 may be configured to execute instructions stored in the memory device 33 or otherwise accessible to the processing element 26. Meanwhile, the communication interface element 29 may be embodied as any device or means embodied in either hardware, software, or a combination of hardware and software that is configured to receive and/or transmit data from/to the network 20 and/or any other device or module in communication with the head unit 22.

When used in the context of guidance services, conventional satellite navigation modules may be configured to provide route determination and/or guidance based on theoretical calculations. Such theoretical calculations, however, may not coincide with real-world situations. Accordingly, exemplary embodiments of the present invention may determine a route based at least in part on data measured or otherwise gathered during previous traversals of a particular route by a particular user. Thus, for example, at one or more times during which a route is traversed, one or more operational parameters may be measured or otherwise gathered, and stored for use in determining future routes. In addition, during traversal of a route, one or more measured operational parameters may be displayed along with corresponding parameters (or other parameters) stored or otherwise formulated in association with a route that may be the same or similar to the respective route. Thus, a user may experience the advantage of viewing operational parameters corresponding to actual logged data from a previous traversal of a route for comparison to the current traversal of the route.

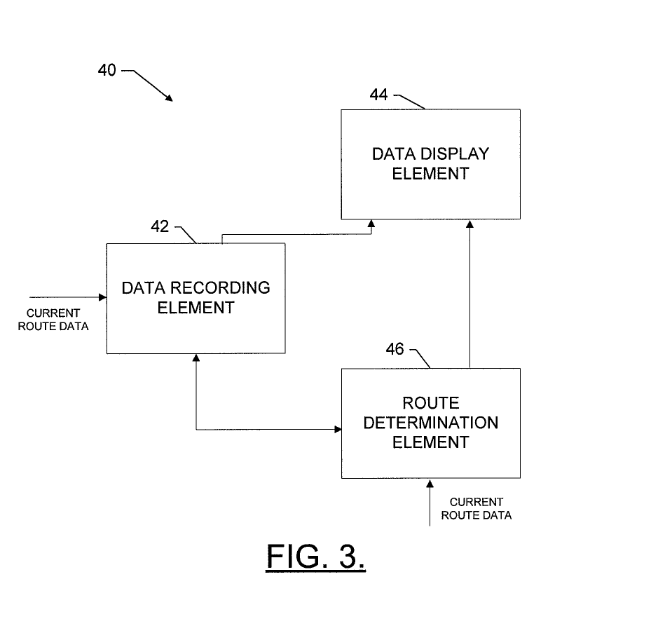

FIG. 3 illustrates a functional block diagram of a navigation system 40 in accordance with exemplary embodiments of the present invention. The navigation system 40 may be embodied, for example, as in software, hardware of a combination of hardware and software. In an exemplary embodiment, the navigation system 40 may include a data recording element 42, a data display element 44, and a route determination element 46. One or more of the data recording element 42, the data display element 44 and the route determination element 46 may be controlled by or embodied as the processing element 26 of FIG. 2. As such, the entirety of the system 40 may be embodied within the head unit 22, or may alternatively be embodied within devices or means accessible to the head unit 22 (e.g., via the network 20).

The data recording element 42 may be any means or device (e.g., memory device 33) configured to receive and store one or more routes, or more one or more segments of one or more routes, as well as one or more operational parameters (e.g., from the instrument module 16) for storage in association with a respective route and/or route segment. The route(s) and/or route segment(s) may be defined by a collection of location data provided, for example, by the navigation module 12. During operation, the data recording element 42 may be in communication with the navigation module 12 and the instrument module 16 in order to store operational parameters (e.g., fuel level, speed, engine RPM (revolutions per minute), engine fluid temperature and/or pressure, battery state of charge, ambient air and/or water temperature, salinity, etc.) in association with location data received from the navigation module 12. In an exemplary embodiment, the data recording element 42 may also store time, date and/or day of the week information in association with the operational parameter(s) and/or location data. As explained herein, the location data in a collection of such data defining a route and/or route segment (e.g., starting point, destination, waypoints between starting point and destination), operational parameter(s), and/or time, date and/or day-of-week during which the operational parameter(s) were measured or otherwise gathered may generally be referred to as “route data.” As such, route data may, for example, correlate a particular time/date and location with one or more operational parameter(s) measured or otherwise gathered at that time/date/day-of-week and place.

The route data may be stored by route or by route segment. In this regard, a route may be defined by at least a particular starting point and a particular destination, and may be further defined by a path taken in transit therebetween. Meanwhile, a route segment may be any portion of a route, and may be defined by two or more locations along the route, where the locations may include a starting point, destination and/or waypoints therebetween. For example, a route segment could be a portion of the route between the starting point and a waypoint, between two waypoints, or between a waypoint and the destination. In an exemplary embodiment, the route data could be stored such that, when the data recording element 42 reaches a limit or threshold for available storage space, new route data replaces a substantially similar amount of old route data. The old route data replaced could be, for example, the oldest route data or route data of a lowest priority. Route data priority could be determined based on a number of different factors such as route frequency (e.g., the number of times a particular route is utilized over a given period of time), route status (e.g., a route containing a segment or an entire route that is indicated to be optimal as described in greater detail below), or the like.

The route determination element 46 may be embodied as any device or means embodied in either hardware, software, or a combination of hardware and software that is configured to direct storage of route data for a current route (or route segment), as well as compare route data associated with the current route (or route segment) with previously stored route data (for previous routes) to determine whether the current route (or route segment) corresponds to a previously stored route (or route segment). In some situations the route determination element 46 may recognize a complete previously stored route, while in other situations the route determination element 46 may determine a stored route based on a collection of route segments from various routes. In this regard, the route determination element 46 may be configured to determine one or more candidate routes the same as or similar to a current route based on route data for one or more stored routes. For example, the route determination element may be configured to determine candidate route(s) based on a match or substantial similarity between the starting point, destination and/or time of departure associated with a current route, and corresponding route data associated with one or more stored routes (or collection of route segments that may form a route).

As indicated above, the route determination element 46 may be configured to direct storage of route data defining a current route (or route segment). This route data may again include, for example, a starting point and destination, and, if so desired, one or more waypoints therebetween. In this regard, the route determination element may be configured to determine the starting point of a current route (and subsequent stored route) based on system startup and/or delay of greater than a threshold amount of time at a particular position. The starting point of a current route could also be automatically determined in response to selection of a destination. Alternatively, the user interface of the system may include a manner, such as a start button, by which a user may provide the starting point of a current route.

As indicated above, a route may include one or more segments defined based on one or more waypoints. One or more of these waypoints may be designated by the user, for example, by selection of specific locations. Alternatively, one or more waypoints may be automatically determined by the route determination element 46 in response to a turn, change of course, change of speed, stop, change from one street to another, or the like.

The route determination element 46 may also be configured to determine the destination of a current route (and subsequent stored route), such as based on a match between a current location and a destination previously defined or set for a particular route. Alternatively, the route determination element may be configured to determine the destination based on a shutdown of the system, a delay of a threshold amount of time at a particular position or a known destination for a particular route, in response to a user input, or in any of a number of other manners.

As also indicated above, the route determination element 46 may be further configured to compare route data associated with the current route (or route segment) with previously stored route data (for previous routes) to determine whether the current route (or route segment) corresponds to a previously stored route (or route segment). The route data comparison may be made on any of the different types of route data for a route, including, for example, the time, date, and/or day of the week associated with the current route and stored routes. In this regard, the route determination element 46 may be configured to determine patterns associated with particular routes in order to enable recognition of a current route as the same or similar to a stored route based on a time and starting point associated with the current route. Accordingly, the route determination element 46 may be configured to automatically recognize a stored route that begins at a particular location at substantially a similar time, date and/or day of the week as a current route. Thus, for example, if a vehicle employing the navigation system 40 is started up from a user's home at 8:00 AM on a weekday, the route determination element 46 may be configured to recognize, based on route data, that the user is likely headed to work and may accordingly begin storing route data for the current route, such as for comparison with stored route data for one or more stored instances of the same and/or similar routes (candidate routes) previously traversed by the user between home and work. In an exemplary embodiment, if more than one route may be determined to be a candidate route based on the starting point and/or time, date and/or day of the week information, the route determination element 46 may be configured to defer route determination until more data is available for assisting in route determination and/or to prompt the user to select a route among a list of candidate routes. A route may be considered similar to a stored route if, for example, the routes have the same starting point and destination, regardless of whether the routes share the same waypoints.

The data display element 44 may be embodied as any device or means embodied in either hardware, software, or a combination of hardware and software that is configured to visually display route data for a current route and for a stored route determined to by the route determination element 46 as the same or similar to the current route. In this regard, the data display element 44 may receive data (e.g., location data and/or operational parameter data) from the navigation module 12 and/or the instrument module 16 for display, from the data recording element 42 and/or the route determination element 46. The user may select one or more types of data for display. For example, the user may select to display fuel economy and/or location data to direct the data display element to visually display fuel economy data and/or location data for both the current route and respective stored route. Alternatively, a “display all” function may be provided to direct the data display element to visually display all available data. In either instance, although the route data for the current route and the route data for the respective stored route may be displayed in a number of different manners, in one exemplary embodiment, the route data for the current route may be displayed at least partially simultaneously with the route data for the respective stored route.

In an exemplary embodiment, the data display element 44 may drive the display 23. In response to the route determination element 46 determining or otherwise recognizing a stored route the same or similar to the current route by, the route determination element 46 may identify the respective stored to the data recording element 42. Route data for the respective stored route may then be communicated from the data recording element 42 to the data display element 44 for display along with the route data for the current route. In this regard, and in particular for the at least partial simultaneous display of the current route data and stored route data, display of the respective route data may be synchronized with respect to, for example, the time of departure or distance from the starting point in each of the routes. Thus, for example, if location data is displayed by the data display element 44, progress along the route path may be displayed for the current route along with an indication of the position at the same relative time within the respective stored route. The user may therefore judge or compare progress during the current route with respect to progress at the same relative time during a previously completed running of the same or similar route. In other words, the data display element 44 may be configured to display current route data and also route data corresponding to a “ghost rider” (e.g., the stored route data) illustrating position or operational parameter data for a route at a corresponding time or position in the stored route.

In an exemplary embodiment, the data display element 44 may be configured to display current route data and stored route data in different and/or distinct manners in order to enable differentiation by the user. For example, current route data and stored route data could be displayed in different colors, in separately labeled display consoles, in association with different icons, etc. The user may be able to select display characteristics regarding the display of the current route data and/or the stored route data.

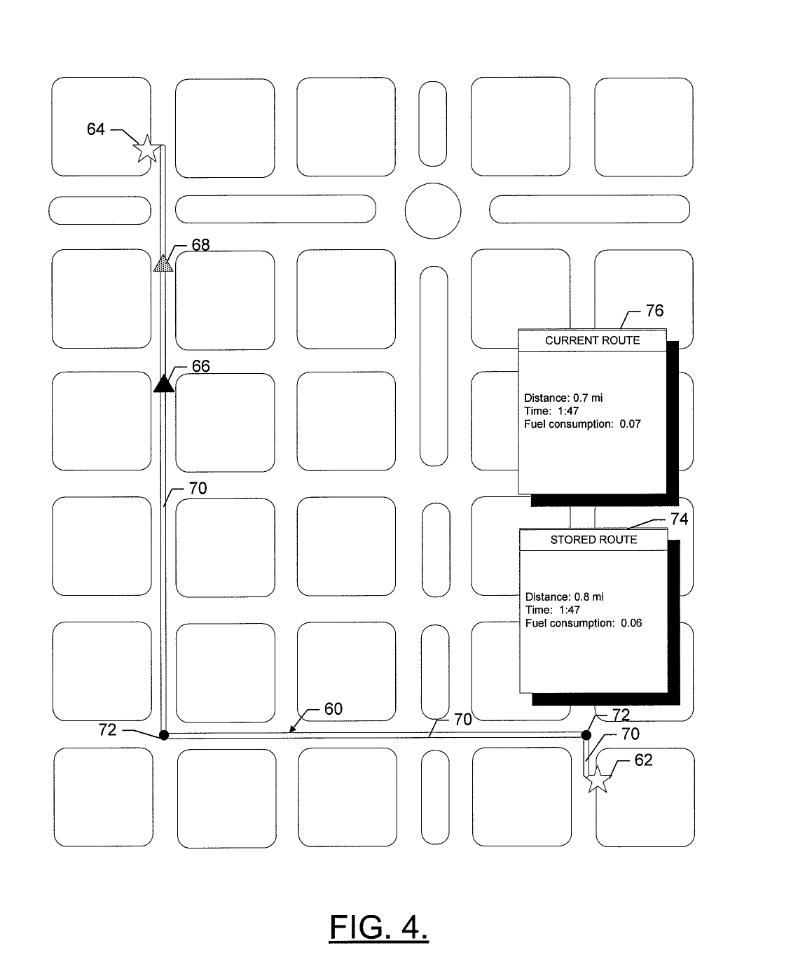

FIG. 4 illustrates a diagram of a display of route data according to an exemplary embodiment of the present invention. The display shows an exemplary stored route 60 between a starting point 62 and a destination 64. Although FIG. 4 illustrates the stored route 60 in its entirety, such a case may not be typical. For example, only a portion of the stored route may be displayed at any one time. As shown in FIG. 4, location data for the navigation system's current position along a current route may be indicated by a first position marker 66, while corresponding location data for a stored route may be indicated by second position marker 68. As described above, the first position marker 66 and the second position marker 68 may be synchronized with respect to their respective departures from the starting point 62. As such, the second position marker 68 may indicate the position of the user at the same relative time during the respective stored route as in the current route. Although not shown in FIG. 4, a trail may also be displayed to indicate the ground covered by the first position marker 66 during transit of the current route.

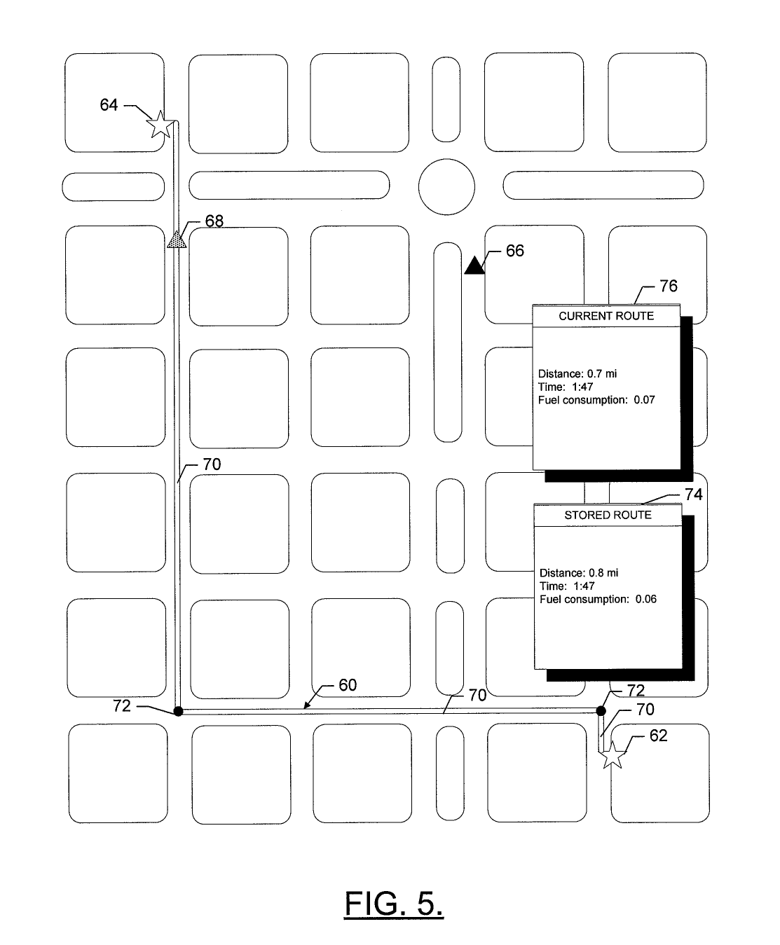

As shown in FIG. 4, route segments 70 may also be displayed with respect to the stored route 60. In the present example, the route segments 70 may correspond to portions of the stored route 60 for which a different street was traversed. Junction points between the route segments 70 may be considered waypoints 72. As explained above, a route may be defined by at least a particular starting point and a particular destination, and as such, the path taken between the starting point and destination need not be identical between the current route and the stored route determined the same or similar to the current route. In other words, the current route need not trace each of the route segments 70 of the respective stored route. As such, for example, the first position marker 66 may deviate from the stored route 60, while the second position marker 68 remains on the stored route 60, as illustrated in FIG. 5.

Returning to FIG. 4, the data display element 44 may also be configured to display a stored-route data console 74 including one or more operational parameters for the time and/or position along the stored route 60 corresponding to the time and/or position along the current route relative to departure from the starting point 62. For example, the stored-route data console 74 may include a time and/or distance from the starting point 62 for the stored route, which may or may not correspond to the current time and/or distance from the starting point 62 in the current route. As also shown, for example, the stored-route data console 74 may also include a fuel consumption at the corresponding time or distance from the starting point 62 in the stored route. The data display element 44 may also be configured to display a current-route data console 76 including one or more operational parameters for the current route. For example, the current-route data console 76 may illustrate a time and/or distance from the starting point 62 in the current route. The stored route data console 74 may also include a fuel consumption at the corresponding time or distance from the starting point 62 in the current route.

Although shown in different consoles, both current-route and stored-route data may be displayed in a single data console. Additionally, although the stored-route data console 74 and the current-route data console 76 are illustrated as providing fuel consumption information, any operational parameter data could additionally or alternatively be displayed. In an exemplary embodiment, data console information may even be displayed without indications of position along the current route and/or stored route. Further, although the consoles are illustrated as including numeric data, it should be understood that one or both of the consoles may additionally or alternatively include operational parameter(s) in the form of graphs, gauge readings, or other like representations.

In an exemplary embodiment, in response to the route determination element 46 determining more than one stored candidate routes the same or similar to the current route, the route determination element 46 may identify, to the data recording element 42, a selected one of those stored candidate routes. Selection of a stored candidate route may be performed in a number of different manners, including based on predefined rules for route selection. The predefined rules may be input by the user. As an alternative, the user may be presented with a list of candidate routes for manual selection. Route data corresponding to the selected candidate stored route may then be communicated to the data display element 44 for display.

In cases in which route selection is performed automatically based on predefined rules, the predefined rules may provide criteria for route selection. The criteria could be, for example, shortest time, shortest distance, best fuel economy, most recent route, etc. Accordingly, for example, if the criterion is shortest time, the route determination element 46 may communicate to the data recording element 42 to have the stored data corresponding to the route between the starting point 62 and the destination 64 that has the shortest overall travel time. Thus, the data recording element 42 may communicate the selected route data to the data display element 44 for simultaneous display with the current route data to enable the user to compare the current route to an optimal route in terms of time.

In an exemplary embodiment, rather than selecting a complete single route meeting the criteria (e.g., the shortest time), an optimal route in terms of time, distance, fuel economy, or in terms of any other operational parameter, may be created from optimal route segments. In other words, for example, rather than selecting a complete route having the best fuel economy, an optimal route could be created from a collection of route segments (possibly from different transit instances of the same or different routes) which combine to provide the best fuel economy for a transit from the starting point 62 to the destination 64. The optimal route may then be provided to the data display element 44 for simultaneous display with the current route data to enable the user to compare the current route to an optimal route in terms of fuel consumption.

As another alternative, an average route may be determined or otherwise formulated based on an average of route data and/or operational parameters associated with a portion of, if not all, multiple stored routes determined the same or similar to the current route. Accordingly, the stored route may be embodied as an average route for simultaneous and synchronized display along with the current route data.

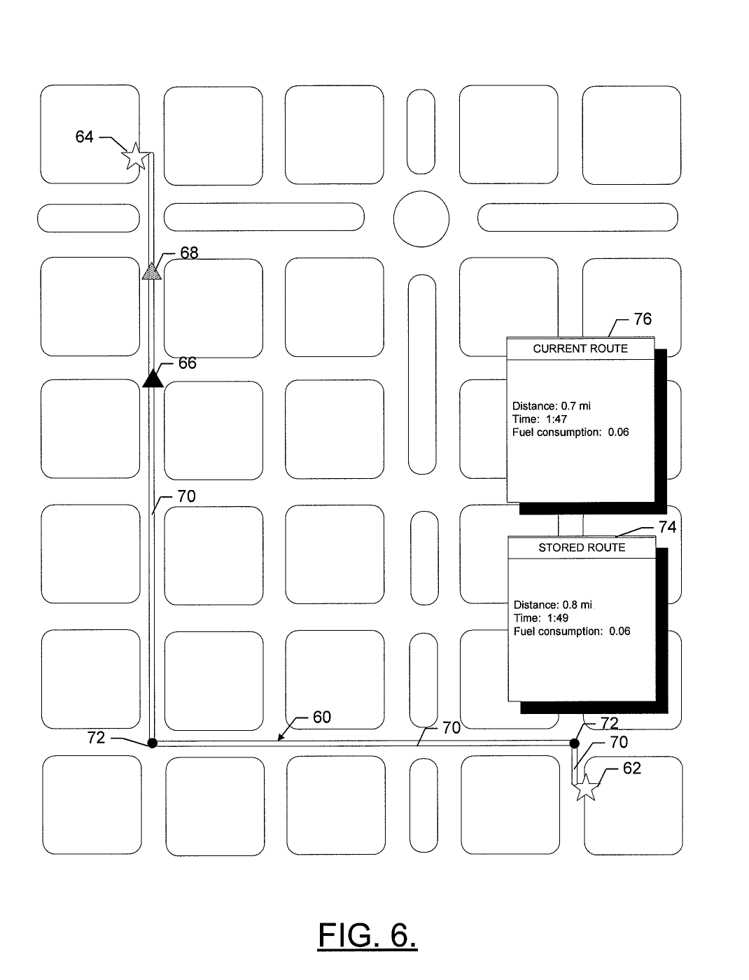

FIGS. 4 and 5 illustrate a display of route data in which current route data is displayed simultaneously with stored route data and synchronized with respect to time from leaving the starting point 62. However, embodiments of the present invention may also be employed to simultaneously illustrate current route data as compared to stored route data with respect to fuel consumption or any other operational parameter as measured from the starting point 62. FIG. 6 illustrates a diagram of a display of route data according to an exemplary embodiment of the present invention in which current route data and stored route data are simultaneously displayed with respect to fuel consumed since departure from the starting point 62.

As shown in FIG. 6, the first position marker 66 may illustrate location data for the navigation system's current position along a current route. Additionally, the current-route data console 76 may include one or more operational parameters for the current route such as fuel consumption. Meanwhile, the stored-route data console 74 may illustrate stored route operational parameter information corresponding to a stored route position marker 82. In this exemplary embodiment, the stored route position marker 82 may display location data for the navigation system's stored position along the stored route for the corresponding fuel consumption with respect to the starting point 62. In other words, in the embodiment of FIG. 6, the stored route position marker 82 illustrates the position of a “ghost rider” when, during the stored route, the “ghost rider” had used the same amount of fuel that has been consumed in the current route. Thus, for example, if the user were to press the accelerator to rapidly increase speed (and consequently also rapidly increase fuel consumption), if we assume the stored route is a candidate route chosen for fuel economy purposes (e.g., most fuel efficient stored route), the user could see the “ghost rider” (e.g., the stored route position marker 82) accelerate ahead of the first position marker 66 since fuel consumption forms the basis upon which the current route is compared to the stored route.

FIG. 6 illustrates an example in which the user has operated in a less fuel efficient manner in transiting the route currently than had been performed in the stored route. As such, for the same fuel consumption, the stored route indicates a user location ahead of the current user location despite the fact that the time consumed to achieve such position may have been greater in respect to the stored route.

Additionally or alternatively, any other operational parameter may be utilized as the basis for synchronizing the display of current and stored route data based on the consumption of the operational parameter in embodiments of the present invention. In this regard, distance traveled, distance to go, estimated battery life, fuel consumption, time since departure, and other parameters may be utilized as the basis for comparison.

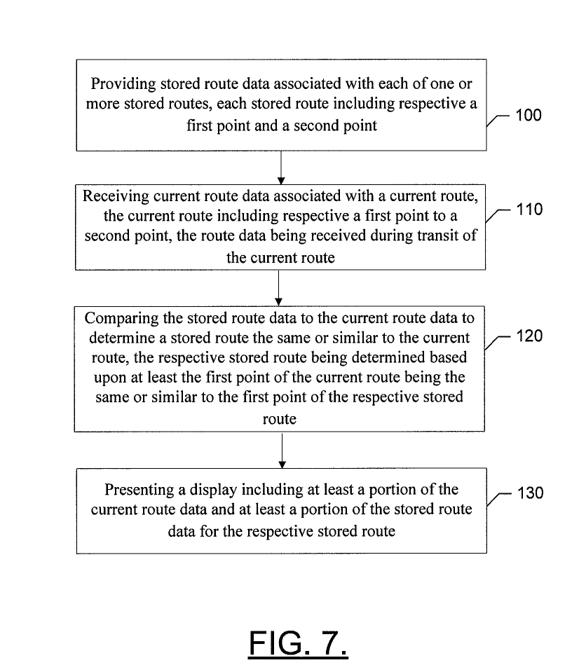

FIG. 7 is a flowchart of a system, method and computer program product according to an exemplary embodiment of the invention. It will be understood that each block or step of the flowchart, and combinations of blocks in the flowchart, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of, for example, the head unit and executed by its processing element 26. As will be appreciated, any such computer program instructions may be loaded onto a computer or other programmable apparatus (i.e., hardware) to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

In this regard, one embodiment of a method of providing utilization of logged data visualization for optimization of an operational parameter associated with a particular route, as shown in FIG. 7, may include providing stored route data associated with each of one or more stored routes, each stored route including respective a first point and a second point at operation 100. At operation 110, current route data associated with a current route may be received in which the current route includes respective a first point to a second point. The route data may be received during transit of the current route. The current route data could include, for example, position data and operational parameter data corresponding to the current route. The method may further include comparing the stored route data to the current route data to determine a stored route the same or similar to the current route, the respective stored route being determined based upon at least the first point of the current route being the same or similar to the first point of the respective stored route at operation 120. The method may also include presenting a display including at least a portion of the current route data and at least a portion of the stored route data for the respective stored route at operation 130. In addition to the starting point, time of departure and/or the destination may also be used in route determination. In an exemplary embodiment, the corresponding stored route may be selected from among a plurality of candidate stored routes on the basis of a time criteria, a distance criteria, or a criteria associated with optimizing an operational parameter. The selected route (e.g., the corresponding stored route) could alternatively be a theoretical optimal route comprising optimal route segments forming different portions of at least two stored routes or an average route comprising an average of each stored route corresponding to the current route. The current route data and stored route data from the corresponding stored route may be displayed such that the current route data and the stored route data are displayed simultaneously and synchronized with respect to the starting point. In an exemplary embodiment, the current route data and the stored route data could be displayed synchronized with respect to distance from the starting point or time from the starting point.

Many modifications and other embodiments of the inventions set forth herein will come to mind to one skilled in the art to which these embodiments pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method comprising:
providing stored route data associated with each of one or more stored routes, each stored route including respective a first point and a second point;
receiving current route data associated with a current route, the current route including respective a first point to a second point, the route data being received during transit of the current route;
comparing the stored route data to the current route data to determine a stored route the same or similar to the current route, the respective stored route being determined based upon at least the first point of the current route being the same or similar to the first point of the respective stored route; and
presenting a display including at least a portion of the current route data and at least a portion of the stored route data for the respective stored route.

2. The method of claim 1, wherein presenting a display comprises presenting a display of the current route data and the stored route data synchronized with respect to a distance from the first point.

3. The method of claim 1, wherein presenting a display comprises presenting a display of the current route data and the stored route data synchronized with respect to a time from the first point.

4. The method of claim 1, wherein presenting a display comprises presenting a display of the current route data and the stored route data synchronized with respect to an operational parameter measured with respect to the first point.

5. The method of claim 1, wherein comparing the stored route data to the current route data comprises comparing the stored route data to the current route data to determine a stored route further based on at least one of time or destination.

6. The method of claim 1, wherein comparing the stored route data to the current route data comprises comparing the stored route data to the current route data to determine a stored route from a plurality of stored routes based on at least one of a time criteria, a distance criteria, or a criteria associated with optimizing an operational parameter.

7. The method of claim 1, comparing the stored route data to the current route data comprises comparing the stored route data to the current route data to determine a theoretical optimal route comprising optimal route segments forming different portions of at least two stored routes.

8. The method of claim 1, wherein comparing the stored route data to the current route data comprises comparing the stored route data to the current route data to determine an average route comprising an average of a plurality of stored routes.

9. The method of claim 1, wherein receiving current route data comprises receiving location data and one or more operational parameters for the current route.

10. A computer program product comprising at least one computer-readable storage medium having computer-readable program code portions stored therein, the computer-readable program code portions comprising:
a first executable portion for providing stored route data associated with each of one or more stored routes, each stored route including respective a first point and a second point;
a second executable portion for receiving current route data associated with a current route, the current route including respective a first point to a second point, the route data being received during transit of the current route;
a third executable portion for comparing the stored route data to the current route data to determine a stored route the same or similar to the current route, the respective stored route being determined based upon at least the first point of the current route being the same or similar to the first point of the respective stored route; and
a fourth executable portion for presenting a display including at least a portion of the current route data and at least a portion of the stored route data for the respective stored route.

11. The computer program product of claim 10, wherein the fourth executable portion includes instructions for presenting a display of the current route data and the stored route data synchronized with respect to a distance from the first point.

12. The computer program product of claim 10, wherein the fourth executable portion includes instructions for presenting a display of the current route data and the stored route data synchronized with respect to a time from the first point.

13. The computer program product of claim 10, wherein the fourth executable portion includes instructions for presenting a display of the current route data and the stored route data synchronized with respect to an operational parameter measured with respect to the first point.

14. The computer program product of claim 10, wherein the third executable portion further includes instructions for comparing the stored route data to the current route data to determine a stored route further based on at least one of time or destination.

15. The computer program product of claim 10, wherein the third executable portion further includes instructions for comparing the stored route data to the current route data to determine a stored route from a plurality of stored routes based on at least one of a time criteria, a distance criteria, or a criteria associated with optimizing an operational parameter.

16. The computer program product of claim 10, wherein the third executable portion includes instructions for comparing the stored route data to the current route data to determine a theoretical optimal route comprising optimal route segments forming different portions of at least two stored routes.

17. The computer program product of claim 10, wherein the third executable portion includes instructions for comparing the stored route data to the current route data to determine an average route comprising an average of a plurality of stored routes.

18. The computer program product of claim 10, wherein the second executable portion includes instructions for receiving location data and one or more operational parameters for the current route.

19. An apparatus comprising:
a data recording element configured to provide stored route data associated with each of one or more stored routes, each stored route including respective a first point and a second point;
a route determining element configured to receive current route data associated with a current route, the current route including respective a first point to a second point, the route data being received during transit of the current route and to compare the stored route data to the current route data to determine a stored route the same or similar to the current route, the respective stored route being determined based upon at least the first point of the current route being the same or similar to the first point of the respective stored route; and
a data display element in communication with the route determining element and the data recording element and configured to present a display including at least a portion of the current route data and at least a portion of the stored route data for the respective stored route.

20. The apparatus of claim 19, wherein the data display element is further configured to present a display of the current route data and the stored route data synchronized with respect to a distance from the first point.

21. The apparatus of claim 19, wherein the data display element is further configured to present a display of the current route data and the stored route data synchronized with respect to a time from the first point.

22. The apparatus of claim 19, wherein the data display element is further configured to present a display of the current route data and the stored route data synchronized with respect to an operational parameter measured with respect to the first point.

23. The apparatus of claim 19, wherein the route determining element is further configured to compare the stored route data to the current route data to determine a stored route further based on at least one of time or destination.

24. The apparatus of claim 19, wherein the route determining element is further configured to compare the stored route data to the current route data to determine a stored route from a plurality of stored routes based on at least one of a time criteria, a distance criteria, or a criteria associated with optimizing an operational parameter.

25. The apparatus of claim 19, wherein the route determining element is further configured to compare the stored route data to the current route data to determine a theoretical optimal route comprising optimal route segments forming different portions of at least two stored routes.

26. The apparatus of claim 19, wherein the route determining element is further configured to compare the stored route data to the current route data to determine an average route comprising an average of a plurality of stored routes.

27. The apparatus of claim 19, wherein the route determining element is further configured to receive location data and one or more operational parameters for the current route.
